(19) United States
(12) Patent Application Publication
(10) Pub. No.: US 2025/0056399 A1
(43) Pub. Date: Feb. 13, 2025

(54) EARLY CELL SWITCHING INDICATION

(71) Applicant: QUALCOMM Incorporated, San Diego, CA (US)

(72) Inventors: Hung Dinh LY, San Diego, CA (US); Kexin XIAO, Shanghai (CN); Wanshi CHEN, San Diego, CA (US)

(21) Appl. No.: 18/718,389

(22) PCT Filed: Feb. 2, 2022
(86) PCT No.: PCT/CN2022/075305

§ 371 Date: Jun. 10, 2024

(51) Int. Cl. H04W 48/20; H04W 74/0833

(52) U.S. Cl. CPC H04W 48/20; H04W 74/0833

(57) ABSTRACT

Methods, systems, and devices for wireless communications are described. A user equipment (UE) may receive, from a network entity, a downlink message associated with a first random access channel (RACH) procedure between the network entity and the UE, the downlink message including an accessibility indicator of a first cell supported by the network entity, the accessibility indicator indicating whether the first cell is inactive at a future time period. The UE may perform one of the first RACH procedure for the first cell based at least in part on the accessibility indicator indicating that the first cell supported by the network entity is active at the future time period or a second RACH procedure for a second cell based at least in part on the accessibility indicator indicating that the first cell supported by the network entity is inactive at the future time period.

### CROSS REFERENCE

The present Application is a 371 national stage filing of International PCT Application No. PCT/CN2022/075305 by L Y et al. entitled “EARLY CELL SWITCHING INDICATION,” filed Feb. 2, 2022, which is assigned to the assignee hereof, and which is expressly incorporated by reference in its entirety herein.

### FIELD OF TECHNOLOGY

The following relates to wireless communications, including early cell switching indication.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

The described techniques relate to improved methods, systems, devices, and apparatuses that support early cell switching indication. Generally, the described techniques provide for mitigating or reducing the effects of cell coverage loss caused by dynamic adaptation.

In some wireless communications systems, a base station may transmit, to a user equipment (UE), an indication of whether a cell associated with (e.g., supported by) the base station is or will be accessible during a random access channel (RACH) procedure for the UE to access the cell (e.g., 4-step RACH procedure, 2-step RACH procedure). For example, the base station may transmit an indication of whether dynamic antenna adaptation or dynamic beam adaptation is being performed or may identify whether dynamic antenna adaptation or dynamic beam adaptation may cause coverage loss at the UE and may transmit an accessibility message during the RACH procedure indicating whether the cell may experience coverage loss. The indication may be a single bit indication or may be a multi-bit indication and may generally convey, to the UE, if the associated cell is accessible/inaccessible.

A method for wireless communication at a user equipment (UE) is described. The method may include receiving, from a network entity, a downlink message associated with a first random access procedure between the network entity and the UE, the downlink message including an accessibility indicator of a first cell supported by the network entity, the accessibility indicator indicating whether the first cell is inactive at a future time period and performing one of the first random access procedure for the first cell based on the accessibility indicator indicating that the first cell supported by the network entity is active at the future time period or a second random access procedure for a second cell based on the accessibility indicator indicating that the first cell supported by the network entity is inactive at the future time period.

An apparatus for wireless communication at a UE is described. The apparatus may include a memory, and a processor coupled to the memory, configured to receive, from a network entity, a downlink message associated with a first random access procedure between the network entity and the UE, the downlink message including an accessibility indicator of a first cell supported by the network entity, the accessibility indicator indicating whether the first cell is inactive at a future time period and perform one of the first random access procedure for the first cell based on the accessibility indicator indicating that the first cell supported by the network entity is active at the future time period or a second random access procedure for a second cell based on the accessibility indicator indicating that the first cell supported by the network entity is inactive at the future time period.

Another apparatus for wireless communication at a UE is described. The apparatus may include means for receiving, from a network entity, a downlink message associated with a first random access procedure between the network entity and the UE, the downlink message including an accessibility indicator of a first cell supported by the network entity, the accessibility indicator indicating whether the first cell is inactive at a future time period and means for performing one of the first random access procedure for the first cell based on the accessibility indicator indicating that the first cell supported by the network entity is active at the future time period or a second random access procedure for a second cell based on the accessibility indicator indicating that the first cell supported by the network entity is inactive at the future time period.

A non-transitory computer-readable medium storing code for wireless communication at a UE is described. The code may include instructions executable by a processor to receive, from a network entity, a downlink message associated with a first random access procedure between the network entity and the UE, the downlink message including an accessibility indicator of a first cell supported by the network entity, the accessibility indicator indicating whether the first cell is inactive at a future time period and perform one of the first random access procedure for the first cell based on the accessibility indicator indicating that the first cell supported by the network entity is active at the future time period or a second random access procedure for a second cell based on the accessibility indicator indicating that the first cell supported by the network entity is inactive at the future time period.

In some examples of the method, apparatuses, and non-transitory computer-readable medium described herein, receiving the downlink message may include operations, features, means, or instructions for receiving downlink control information including scheduling information for a message of the first random access procedure.

In some examples of the method, apparatuses, and non-transitory computer-readable medium described herein, receiving the downlink message may include operations, features, means, or instructions for receiving downlink control information including scheduling information for a message of the first random access procedure, where the first random access procedure may be a four-step random access procedure and the message may be a Msg2 of the four-step random access procedure.

In some examples of the method, apparatuses, and non-transitory computer-readable medium described herein, receiving the downlink message may include operations, features, means, or instructions for receiving downlink control information including scheduling information for a message of the first random access procedure, where the first random access procedure may be a two-step random access procedure and the message may be a MsgB of the two-step random access procedure.

In some examples of the method, apparatuses, and non-transitory computer-readable medium described herein, receiving the downlink message may include operations, features, means, or instructions for receiving downlink control information including scheduling information for a message of the first random access procedure, where downlink control information includes a set of multiple reserved bits and the indication of the accessibility of the first cell includes a bit of the set of multiple reserved bits.

In some examples of the method, apparatuses, and non-transitory computer-readable medium described herein, receiving the downlink message may include operations, features, means, or instructions for receiving downlink control information including scheduling information for a message of the first random access procedure, where the downlink control information further includes a cyclic redundancy check that may be scrambled by an identifier of the message.

In some examples of the method, apparatuses, and non-transitory computer-readable medium described herein, receiving the downlink message may include operations, features, means, or instructions for receiving downlink control information including scheduling information for a message of the first random access procedure, where the first random access procedure may be a four-step random access procedure and the message may be a Msg4 of the four-step random access procedure.

In some examples of the method, apparatuses, and non-transitory computer-readable medium described herein, receiving the downlink message may include operations, features, means, or instructions for receiving a physical downlink control channel including downlink control information that schedules a message of the first random access procedure.

In some examples of the method, apparatuses, and non-transitory computer-readable medium described herein, receiving the downlink message may include operations, features, means, or instructions for receiving a physical downlink control channel including downlink control information that schedules a message of the first random access procedure, where the physical downlink control channel further includes a demodulation reference signal including the accessibility indicator.

In some examples of the method, apparatuses, and non-transitory computer-readable medium described herein, receiving the downlink message may include operations, features, means, or instructions for receiving a physical downlink control channel including downlink control information that schedules a message of the first random access procedure, where the message may be a Msg2 or a Msg4.

In some examples of the method, apparatuses, and non-transitory computer-readable medium described herein, receiving the downlink message may include operations, features, means, or instructions for receiving a reserved bit of a medium access control sub-header or a medium access control payload of the downlink message, where the downlink message may be a response message of the first random access procedure.

In some examples of the method, apparatuses, and non-transitory computer-readable medium described herein, receiving the downlink message may include operations, features, means, or instructions for receiving a reserved bit of a medium access control sub-header or a medium access control payload of the downlink message, where the downlink message may be a MsgB of the first random access procedure.

Some examples of the method, apparatuses, and non-transitory computer-readable medium described herein may further include operations, features, means, or instructions for receiving a message instructing the UE to perform the second random access procedure for the second cell based on the accessibility indicating that the first cell may be inaccessible.

In some examples of the method, apparatuses, and non-transitory computer-readable medium described herein, receiving the message may include operations, features, means, or instructions for receiving an indication including a cell identifier, a sync raster frequency, a set of random access parameters, an indication of whether the second cell supports one or more power savings features, or a combination thereof.

In some examples of the method, apparatuses, and non-transitory computer-readable medium described herein, receiving the message may include operations, features, means, or instructions for receiving the message via a Msg2 of a four-step random access procedure, a Msg4 of a four-step random access procedure, or a MsgB of a two-step random access procedure.

A method for wireless communication at a network entity is described. The method may include receiving, from a UE, an uplink message associated with a random access procedure between the UE and a cell supported by the network entity and transmitting, to the UE and in response to the uplink message, a downlink message associated with the random access procedure between the UE and the cell, the downlink message including an accessibility indicator of the cell supported by the network entity, the accessibility indicator indicating whether the cell is inactive at a future time period.

An apparatus for wireless communication at a network entity is described. The apparatus may include a memory and a processor coupled to the memory, and configured to receive, from a UE, an uplink message associated with a random access procedure between the UE and a cell supported by the network entity and transmit, to the UE and in response to the uplink message, a downlink message associated with the random access procedure between the UE and the cell, the downlink message including an accessibility indicator of the cell supported by the network entity, the accessibility indicator indicating whether the cell is inactive at a future time period.

Another apparatus for wireless communication at a network entity is described. The apparatus may include means for receiving, from a UE, an uplink message associated with a random access procedure between the UE and a cell supported by the network entity and means for transmitting, to the UE and in response to the uplink message, a downlink message associated with the random access procedure between the UE and the cell, the downlink message including an accessibility indicator of the cell supported by the network entity, the accessibility indicator indicating whether the cell is inactive at a future time period.

A non-transitory computer-readable medium storing code for wireless communication at a network entity is described. The code may include instructions executable by a processor to receive, from a UE, an uplink message associated with a random access procedure between the UE and a cell supported by the network entity and transmit, to the UE and in response to the uplink message, a downlink message associated with the random access procedure between the UE and the cell, the downlink message including an accessibility indicator of the cell supported by the network entity, the accessibility indicator indicating whether the cell is inactive at a future time period.

In some examples of the method, apparatuses, and non-transitory computer-readable medium described herein, transmitting the downlink message may include operations, features, means, or instructions for transmitting downlink control information including scheduling information for a message of the random access procedure.

In some examples of the method, apparatuses, and non-transitory computer-readable medium described herein, transmitting the downlink message may include operations, features, means, or instructions for transmitting downlink control information including scheduling information for a message of the random access procedure, where the random access procedure may be a four-step random access procedure and the message may be a Msg2 of the four-step random access procedure.

In some examples of the method, apparatuses, and non-transitory computer-readable medium described herein, transmitting the downlink message may include operations, features, means, or instructions for transmitting downlink control information including scheduling information for a message of the random access procedure, where the random access procedure may be a two-step random access procedure and the message may be a MsgB of the two-step random access procedure.

In some examples of the method, apparatuses, and non-transitory computer-readable medium described herein, transmitting the downlink message may include operations, features, means, or instructions for transmitting downlink control information including scheduling information for a message of the random access procedure, where the downlink control information includes a set of multiple reserved bits and the indication of the accessibility of the cell includes a bit of the set of multiple reserved bits.

In some examples of the method, apparatuses, and non-transitory computer-readable medium described herein, transmitting the downlink message may include operations, features, means, or instructions for transmitting downlink control information including scheduling information for a message of the random access procedure, where the downlink control information further includes a cyclic redundancy check that may be scrambled by an identifier of the message.

In some examples of the method, apparatuses, and non-transitory computer-readable medium described herein, transmitting the downlink message may include operations, features, means, or instructions for transmitting downlink control information including scheduling information for a message of the random access procedure, where the random access procedure may be a four-step random access procedure and the message may be a Msg4 of the four-step random access procedure.

In some examples of the method, apparatuses, and non-transitory computer-readable medium described herein, transmitting the downlink message may include operations, features, means, or instructions for transmitting a physical downlink control channel including downlink control information that schedules a message of the random access procedure.

In some examples of the method, apparatuses, and non-transitory computer-readable medium described herein, transmitting the downlink message may include operations, features, means, or instructions for transmitting a physical downlink control channel including downlink control information that schedules a message of the random access procedure, where the physical downlink control channel further includes a demodulation reference signal including the indication of the accessibility of the cell.

In some examples of the method, apparatuses, and non-transitory computer-readable medium described herein, transmitting the downlink message may include operations, features, means, or instructions for transmitting a physical downlink control channel including downlink control information that schedules a message of the random access procedure, where the message may be a Msg2 or a Msg4.

In some examples of the method, apparatuses, and non-transitory computer-readable medium described herein, transmitting the downlink message may include operations, features, means, or instructions for transmitting a reserved bit of a medium access control sub-header or a medium access control payload of the downlink message; and where the downlink message may be a response message of the random access procedure.

In some examples of the method, apparatuses, and non-transitory computer-readable medium described herein, transmitting the downlink message may include operations, features, means, or instructions for transmitting a reserved bit of a medium access control sub-header or a medium access control payload of the downlink message, where the downlink message may be a MsgB of the random access procedure.

Some examples of the method, apparatuses, and non-transitory computer-readable medium described herein may further include operations, features, means, or instructions for transmitting a message instructing the UE to perform a second random access procedure between UE and a second cell based on the accessibility indicator indicating that the cell may be inactive at the future time period.

In some examples of the method, apparatuses, and non-transitory computer-readable medium described herein, transmitting the message may include operations, features, means, or instructions for transmitting an indication including a cell identifier, a sync raster frequency, a set of random access parameters, an indication of whether the second cell supports one or more power savings features, or a combination thereof.

In some examples of the method, apparatuses, and non-transitory computer-readable medium described herein, transmitting the message may include operations, features, means, or instructions for transmitting the message via a Msg2 of a four-step random access procedure, a Msg4 of a four-step random access procedure, or a MsgB of a two-step random access procedure.

### BRIEF DESCRIPTION OF THE DRAWINGS

FIG. 1 illustrates an example of a wireless communications system that supports early cell switching indication in accordance with aspects of the present disclosure.

FIG. 2 illustrates an example of a wireless communications system that supports early cell switching indication in accordance with aspects of the present disclosure.

FIG. 3 illustrates an example of a process flow that supports early cell switching indication in accordance with aspects of the present disclosure.

FIGS. 4 and 5 show block diagrams of devices that support early cell switching indication in accordance with aspects of the present disclosure.

FIG. 6 shows a block diagram of a communications manager that supports early cell switching indication in accordance with aspects of the present disclosure.

FIG. 7 shows a diagram of a system including a device that supports early cell switching indication in accordance with aspects of the present disclosure.

FIGS. 8 and 9 show block diagrams of devices that support early cell switching indication in accordance with aspects of the present disclosure.

FIG. 10 shows a block diagram of a communications manager that supports early cell switching indication in accordance with aspects of the present disclosure.

FIG. 11 shows a diagram of a system including a device that supports early cell switching indication in accordance with aspects of the present disclosure.

FIGS. 12 through 15 show flowcharts illustrating methods that support early cell switching indication in accordance with aspects of the present disclosure.

### DETAILED DESCRIPTION

In some wireless communications systems, some devices (a user equipment (UE), a base station, etc.) may support multiple input multiple output (MIMO) communications, in which a device transmits and receives multiple signals using different spatial layers. In some cases, a device may transmit and receive the multiple signals using multiple antennas, beams, combinations of antennas, or combinations or beams. For instance, a base station may have multiple antenna panels, where each antenna panel includes multiple antenna elements. In such cases, each antenna element may be associated with one or more radio frequency (RF) components. The use of a relatively large number of antenna elements (and corresponding RF components), however, may be associated with considerable power consumption. Thus, as the quantity of antenna elements increases, the power consumption may also increase; consequently, power consumption in a system increases with the number of multiple-panel base stations.

A base station may perform adaptive procedures to adjust power consumption, for instance, based on traffic, channel conditions, or the like. For example, the base station may perform dynamic antenna adaptation by dynamically activating or deactivating (e.g., turning off, powering down) a subset of antenna panels or antenna subpanels. If traffic in a cell served by the base station is relatively low, the base station may reduce the number of active panels, which may conserve power while providing service to the cell, but may thereby decrease the total coverage of the cell. Such techniques may be referred to as panel adaptation, dynamic antenna adaptation, dynamic beam adaptation, or other terminology.

These dynamic adaptations may incur cell coverage loss due to the reduced transmit power and beamforming gain, and according to some implementations (e.g., implementations including coverage and capacity optimization), may allow another cell to compensate for the coverage loss for a cell experiencing coverage loss. Thus cell coverage loss may occur at a base station performing dynamic adaptations.

In some examples, the dynamic antenna adaptation or dynamic beam adaptation may be scheduled or may occur before traffic from a served UE arrives (e.g., based on UE feedback (e.g., predicted traffic and channel state information (CSI) report)), thus cell coverage loss may occur before the arrival of traffic as another cell is compensating for the coverage loss. That is, a UE may attempt to access the network shortly before a new antenna/beam configuration is applied, and may experience coverage loss with a first cell due to the new configuration. The UE may then initiate a cell handover procedure to another cell despite just having connected with the first cell. Hence, accessing the first cell may be inefficient for the UE and methods or techniques to avoid completing connection procedures with a cell experiencing coverage loss may increase efficiency in the wireless communications system.

The UE may perform early cell switching to avoid performing a full connection procedure with a cell experience cell coverage loss due to dynamic adaptation schemes. These techniques may also apply to early/dynamically offloading of a UE to a new cell for load balancing performed by the cell.

For example, a base station may transmit an indication of whether the cell is or will be accessible during a random access channel (RACH) procedure for the UE cell-access (e.g., 4-step RACH procedure, 2-step RACH procedure). For example, the base station may transmit an indication of whether dynamic antenna adaptation or dynamic beam adaptation is being performed or may identify whether dynamic antenna adaptation or dynamic beam adaptation may cause coverage loss at the UE and may transmit an indication accordingly indicating to the UE whether the cell may experience coverage loss. The indication may be a single bit indication or may be a multi-bit indication and may generally convey if the cell is accessible or inaccessible.

Aspects of the disclosure are initially described in the context of wireless communications systems. Aspects of the disclosure are then described in the context of a process flow. Aspects of the disclosure are further illustrated by and described with reference to apparatus diagrams, system diagrams, and flowcharts that relate to early cell switching indication.

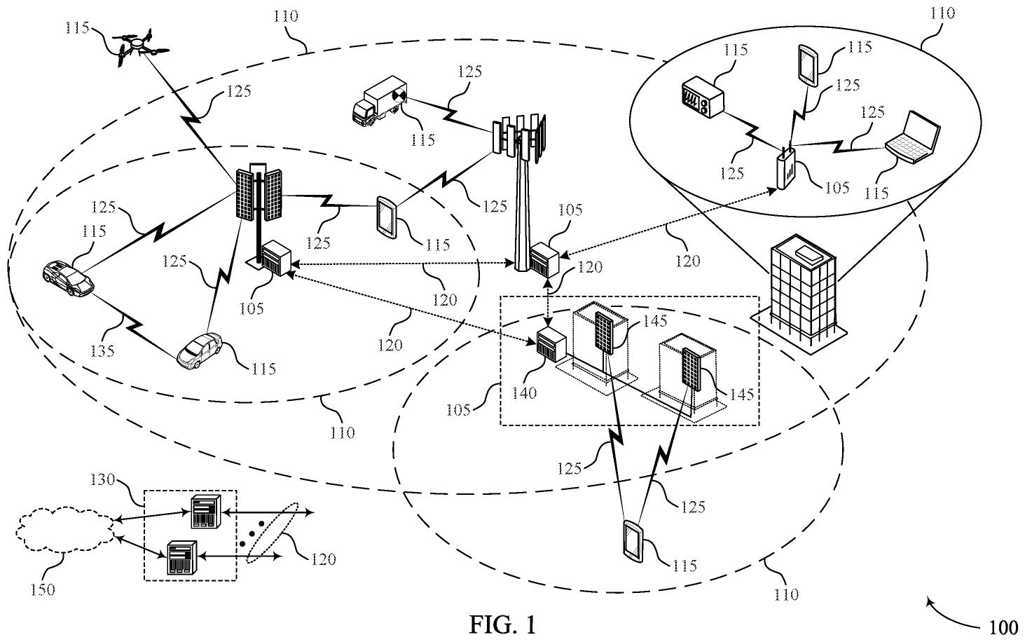

FIG. 1 illustrates an example of a wireless communications system 100 that supports early cell switching indication in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, base station 105, entity of a core network 130, apparatus, device, or computing system configured to perform any techniques described herein. For example, a network node may be a UE 115. As another example, a network node may be a base station 105. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different. Similarly, reference to a UE 115, a base station 105, an apparatus, a device, or a computing system may include disclosure of the UE 115, base station 105, apparatus, device, or computing system being a network node. For example, disclosure that a UE 115 is configured to receive information from a base station 105 also discloses that a first network node is configured to receive information from a second network node. In this example, consistent with this disclosure, the first network node may refer to a first UE 115, a first base station 105, a first apparatus, a first device, or a first computing system configured to receive the information; and the second network node may refer to a second UE 115, a second base station 105, a second apparatus, a second device, or a second computing system.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δ_{fmax}·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

Base stations 105 in the wireless communications system 100 may have any number of antenna elements and antenna panels. For example, massive MIMO operations may be supported by relatively large numbers of antenna panels. However, as the number of antenna elements increases, power consumption at a base station 105 increases. In some examples, a base station 105 may perform panel adaptation by turning on or off (i.e., activating or deactivating) a subset of antenna panels or subpanels, for example, to reduce such power consumption. For instance, if traffic in a cell served by the base station 105 is relatively low, the base station 105 may deactivate some antenna panels. As another example, the base station 105 may reduce (e.g., deactivate) the number of antenna panels or antenna elements when switching from full duplex communications to half duplex communications, in which uplink and downlink transmissions may be transmitted in different time resources (e.g., instead of a same time resource, as in full duplex communications).

As panel adaptation at a base station 105 changes the configuration of the antenna panels and antenna elements, panel adaptation may modify the number of antenna elements used to transmit and receive signals over a wireless channel, which may in turn impact or otherwise modify communications between the base station 105 and other devices, such as a UE 115. For example, a UE 115 may attempt to access a cell supported by the base station 105 by initiating a RACH procedure with the base station 105 shortly before a new antenna/beam configuration is applied by the base station 105. This may cause the UE 115 to experience coverage loss due to the new configuration. That is, a UE 115 may be in the midst of performing an access procedure with a cell when a new configuration is applied by the base station 105 that alters the coverage of the cell, such that the outcome of the access procedure would cause the UE 115 to be connected to a cell without coverage. Thus, deterring a UE 115 from performing an access procedure with a cell that is about to experience coverage reduction or loss may increase efficiency of communications at the UE 115.

To mitigate such impacts, a base station 105 may transmit an accessibility indication during a RACH procedure between the UE 115 and a cell associated with the base station 105, which may indicate whether the cell associated with the base station 105 is inactive at a future time period. For example, the base station 105 may receive, from a UE 115, an uplink RACH message associated with a RACH procedure between the UE 115 and a cell supported by the base station 105. The base station 105 may transmit, to the UE 115 and in response to the uplink RACH message, a downlink message associated with the RACH procedure between the UE 115 and the cell, the downlink message may include an accessibility indicator associated with the cell supported by the base station 105 that may indicate whether the cell is inactive at a future time period.

Based on receiving the accessibility indicator, the UE 115 may continue to perform the first RACH procedure for the cell based on the accessibility indicator indicating that the cell supported by the base station 105 is active at the future time period or may perform a second RACH procedure for a second cell supported by the base station 105 or another base station 105 based on the accessibility indicator indicating that the cell supported by the base station 105 is inactive at the future time period.

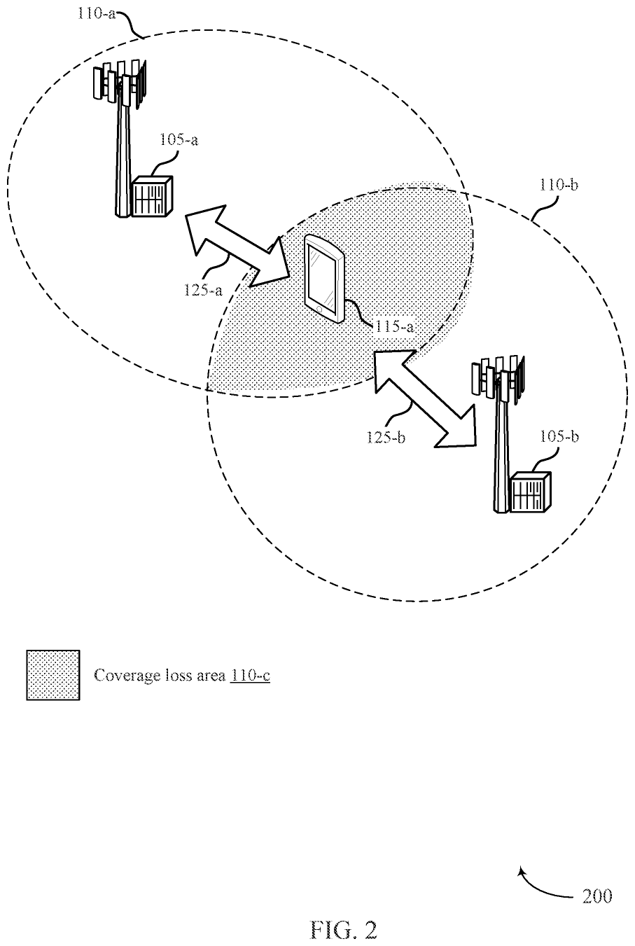

FIG. 2 illustrates an example of a wireless communications system 200 that supports early cell switching indication in accordance with aspects of the present disclosure. In some examples, wireless communications system 200 may implement aspects of wireless communications system 100. Wireless communications system 200 may include a first cell associated with a coverage area 110-a that is supported by base station 105-a, a second cell associated with a coverage area 110-b that is supported by base station 105-b, and a UE 115-a which may be examples of the corresponding devices as described with reference to FIG. 1. In some examples, coverage area 110-a and 110-b may both be supported by base station 105-a.

In some examples, the base station 105-a may transmit an accessibility indication that indicates whether the first cell associated with the coverage area 110-a is or will be accessible to the UE 115-a, where the accessibility indication is transmitted during a RACH procedure (e.g., a four-step RACH procedure or a two-step RACH procedure) performed by the UE 115-a for accessing the first cell associated with the coverage area 110-a. In some examples, the accessibility indication may be a single bit indication or a multi-bit indication. For example, the base station 105-a may determine or detect that the UE 115-a is in coverage loss area 110-c (e.g., based on a physical RACH measurement performed by the base station 105-a). Coverage loss area 110-c may correspond to an area initially supported by the first cell associated with base station 105-a and the second cell associated with base station 105-b. Based on panel adaptation, dynamic panel adaptation, or dynamic antenna adaptation, the base station 105-a may determine to reduce the coverage area 110-a associated with the first cell. That is, the base station 105-a may drop coverage of the coverage loss area 110-c such that the coverage loss area 110-c may be supported by the second cell associated with the base station 105-b and may not be supported by the first cell associated with the coverage area 110-a.

In such examples, the UE 115-a may be attempting to access the first cell supported by the base station 105-a by initiating a RACH procedure with the base station 105-a shortly before a new antenna/beam configuration is applied by the base station 105-a for reducing the coverage area 110-a (e.g., dropping coverage of coverage loss area 110-c). This may cause the UE 115-a to experience coverage loss due to the new configuration. That is, the UE 115-a may be in the midst of performing an access procedure with the first cell when the new configuration is applied by the base station 105-a that alters the coverage area 110-a of the first cell, such that the outcome of the access procedure would cause the UE 115-a to attempt to be connected to a cell that does not include coverage of the UE 115-a. Thus, deterring the UE 115-a from performing an access procedure with the first cell (e.g., that is about to experience coverage reduction or loss) may increase efficiency of communications at the UE 115.

To mitigate such impacts, the base station 105-a may transmit an accessibility indication during a RACH procedure between the UE 115 and a cell associated with the base station 105 via communication link 125-a, which may indicate whether the first cell associated with the coverage area 110-a is inactive at a future time period (e.g., from the perspective of the UE 115-a). For example, the base station 105-a may receive, from the UE 115-a, an uplink RACH message associated with a RACH procedure between the UE 115 and the first cell supported by the base station 105-a. The base station 105-a may transmit, to the UE 115-a and in response to the uplink RACH message, a downlink message associated with the RACH procedure between the UE 115-a and the first cell associated with the coverage area 110-a. The downlink message may include an accessibility indicator associated with the first cell associated with the coverage area 110-a that may indicate whether the first cell associated with coverage area 110-a is inactive at a future time period for the UE 115-a.

Based on receiving the accessibility indicator, the UE 11-a may continue to perform the first RACH procedure for the first cell based on the accessibility indicator indicating that the first cell supported by the base station 105-a is active at the future time period (e.g., will not experience coverage loss) or may perform a second RACH procedure, via communication link 125-b, for a second cell associated with coverage area 110-b and supported by the base station 105-b based on the accessibility indicator indicating that the cell supported by the base station 105-a is inactive (e.g., for the UE 115-a) at the future time period.

In some examples, the accessibility indication may be included in downlink control information (DCI) that schedules a Msg2 physical downlink shared channel (PDSCH) of a four-step RACH procedure. For example, the accessibility indication may be included in a DCI format 1_0 with CRC scrambled by a RA-RNTI of a four-step RACH procedure). In such examples, the accessibility indication may be transmitted in a reserved bit of the DCI format 1_0.

In some examples, the accessibility indication may be included in a DCI that schedules a MsgB PDSCH of a two-step RACH procedure. For example, that indication may be included in a DCI format 1_0 with CRC scrambled by a MsgB-RNTI of a two-step RACH procedure). In such examples, the accessibility indication may be transmitted in a reserved bit of the DCI format 1_0. In such examples, if a C-RNTI MAC CE was included in the MsgA, then the UE 115-a may monitor the physical downlink control channel (PDCCH) of the secondary cell (e.g., SpCell) for a random access response (RAR) identified by the C-RNTI while a msgBResponse Window is active.

In some examples, the accessibility indication may be included in a demodulation reference signal (DMRS) of a PDCCH carrying DCI scheduling a Msg2 PDSCH of a four-step RACH procedure. In some examples, the accessibility indication may be included in a DMRS of PDCCH carrying DCI scheduling a MsgB PDSCH of a two-step RACH procedure. For example, the base station 105-a may transmit, via communication link 125-a, two separate sets of DMRS to indicate “0” or “1,” for example, for a one bit accessibility indication.

In some examples, the accessibility indication may be included in a Msg2 PDSCH of a four-step RACH procedure. For example, the base station 105-a may use a reserved bit in a MAC sub-header for a RAR or in a MAC payload for a RAR. In some examples, the accessibility indication may be provided based on the first cell having a different RAPID range for accessibility and inaccessibility.

In some examples, the accessibility indication may be included in a MsgB PDSCH of a two-step RACH procedure. For example, the base station 105-a may use a reserved bit in a MAC sub-header for a MsgB or in a MAC payload for a MsgB. In some examples, the accessibility indication may be provided based on the first cell having a different RAPID range for accessibility and inaccessibility.

For a four-step RACH procedure, the accessibility indication may be included in DCI scheduling a Msg4 PDSCH, or in a DMRS of a PDCCH carrying DCI that schedules a Msg4 PDSCH, or in a Msg4 PDSCH. Because multiple UE 115 may use a same RO and the same preambles in a Msg1 of a RACH procedure and in order to indicate cell switching to the specific UEs 115, Msg4 related channels may be used for the accessibility indication.

In some examples, when the first cell is not accessible, the base station 105-a may provide additional information about a neighbor cell (e.g., the second cell associated with the coverage area 110-b) (e.g., target cell) to which the UE 115-a should access or switch.

In some examples, the accessibility indication may include a cell ID (e.g., of the second cell), a sync raster frequency (e.g., the UE 115-a may avoid searching for SSBs in many frequency hypotheses), RACH parameters (e.g., the UE may avoid reading SIBI of the second cell before RACH performing the second RACH procedure). In some examples, the accessibility indication may indicate whether the second cell supports green network features or network power savings features, or both.

In some examples, the accessibility indication may be included in a Msg2 of a four-step RACH procedure. For example, the UE 115-a may receive the Msg2 and may perform a first set of steps if the cell is indicated as accessible or active or may perform a second set of steps if the cell is indicated as inaccessible or inactive. That is, the UE 115-a may interpret the received Msg2 according to the indication.

In some examples, the accessibility indication may be included in a Msg4 of a four-step RACH procedure. For example, the UE 115-a may receive the Msg4 and may perform a first set of steps if the cell is indicated as accessible or active or may perform a second set of steps if the cell is indicated as inaccessible or inactive. That is, the UE 115-a may interpret the received Msg4 according to the indication.

In some examples, the accessibility indication may be included in a MsgB of a two-step RACH procedure. For example, the UE 115-a may receive the MsgB and may perform a first set of steps if the first cell is indicated as accessible or active or may perform a second set of steps if the first cell is indicated as inaccessible or inactive. That is, the UE 115-a may interpret the received MsgB according to the indication.

Based on receiving the accessibility indicator, the UE 115-a may continue to perform the first RACH procedure for the first cell based on the accessibility indicator indicating that the first cell supported by the base station 105-a and associated with the coverage area 110-a is active at the future time period (e.g., will not experience coverage loss of the coverage loss area 110-c) or may perform a second RACH procedure for the second cell supported by the base station 105-b based on the accessibility indicator indicating that the first cell supported by the base station 105-a is inactive at the future time period (e.g., will lose coverage of the coverage loss area 110-c).

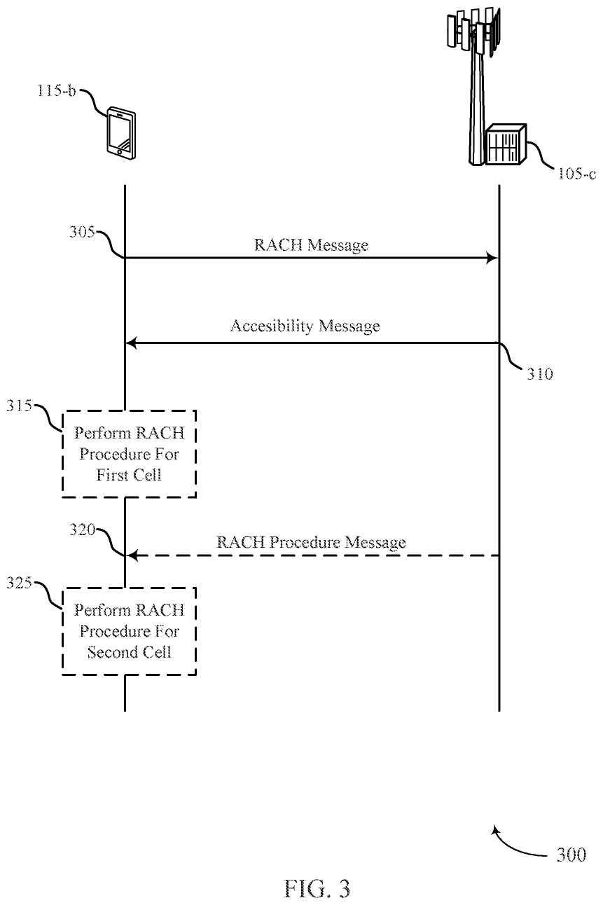

FIG. 3 illustrates an example of a process flow 300 that supports early cell switching indication in accordance with aspects of the present disclosure. The process flow 300 may implement or be implemented by aspects of wireless communications system 100 or 200. For example, the process flow 300 may illustrate operations between a UE 115-b and a base station 105-c, which may be examples of a UE 115 and a base station 105, as described with reference to FIG. 1. In the following description of the process flow 300, the operations between the UE 115-b and the base station 105-c may be transmitted in a different order than the example order shown, or the operations performed by the UE 115-b and the base station 105-c may be performed in different orders or at different times or by different devices. Some operations may also be omitted from the process flow 300, and other operations may be added to the process flow 300.

At 305, the UE 115-b may transmit an uplink message (e.g., Msg 1, MsgA, RACH message) associated with a RACH procedure between the UE 115-b and a first cell associated with the base station 105-b.

At 310, the UE 115-b may receive an accessibility message based at least in part on transmitting the RACH message. The accessibility message may be associated with the RACH procedure between the UE 115-b and the first cell associated with the base station 105-c and may indicate whether the first cell will be inactive at a future time period due to dynamic beam adaptation or dynamic antenna adaptation.

In some examples, the accessibility message may include DCI including scheduling information for a message of the RACH procedure associated with the first cell. In some examples, the accessibility message may include DCI including scheduling information for a Msg2 message of a four-step RACH procedure associated with the first cell.

In some examples, the accessibility message may include DCI including scheduling information for a MsgB of a two-step RACH procedure associated with the first cell. In some examples, the accessibility message may include DCI including scheduling information for a message of the RACH procedure associated with the first cell, where the DCI includes a plurality of reserved bits and the accessibility indicator of the first cell comprises a bit of the plurality of reserved bits.

In some examples, the accessibility message may include DCI including scheduling information for a message of the RACH procedure associated with the first cell, where the DCI further includes a CRC that is scrambled by an identifier (e.g., RNTI) of the message. In some examples, the accessibility message may include DCI including scheduling information for a Msg4 of a four-step RACH procedure associated with the first cell.

In some examples, the accessibility message may include a PDCCH including DCI that schedules a message of the RACH procedure associated with the first cell. In some examples, the PDCCH may further include a DMRS including an accessibility indicator. In some examples, the message may be a Msg2 or a Msg 4 of a four-step RACH procedure associated with the first cell.

In some examples, the accessibility message may include a reserved bit of a MAC sub-header or a MAC payload of a MsgB of a two-step RACH procedure associated with the first cell.

In some examples, at 315, the UE 115-b may perform a RACH procedure for the first cell associated with the base station 105-b based on the accessibility message indicating that the first cell is active at the future time period.

In some examples, at 320, the UE 115-b may receive a message instructing the UE 115-b to perform the second RACH procedure for a second cell associated with the base station 105-c or another base station 105, based on the accessibility message indicating that the first cell is inaccessible. In some examples, the message instructing the UE 115-b to perform the second RACH procedure may be received via a Msg2 of a four-step RACH procedure, a Msg4 of a four-step RACH procedure, or a MsgB of a two-step RACH procedure.

In some examples, at 325, the UE 115-b may perform a RACH procedure for a second cell associated with the base station 105-b or another base station 105 based on the accessibility message indicating that the first cell supported by the network entity is inactive at the future time period or based on receiving the message instructing the UE 115-b to perform the second RACH procedure, or both.

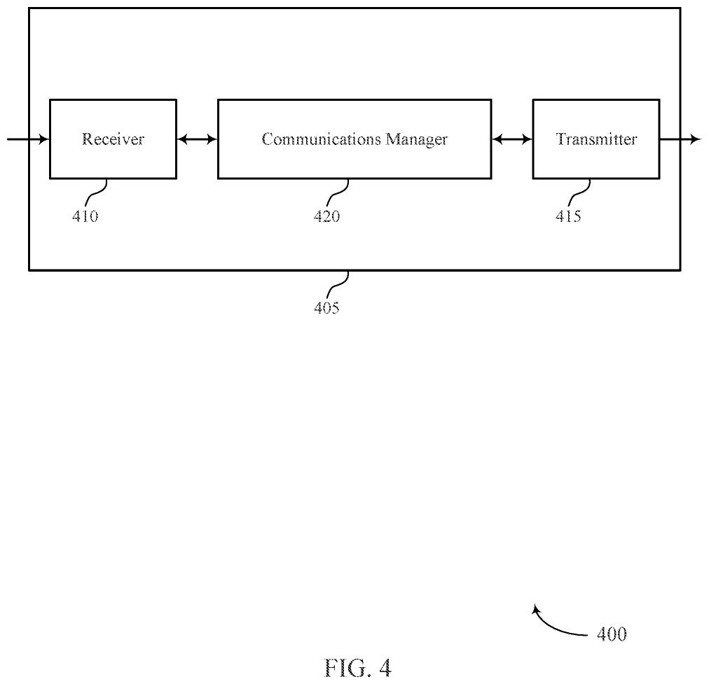

FIG. 4 shows a block diagram 400 of a device 405 that supports early cell switching indication in accordance with aspects of the present disclosure. The device 405 may be an example of aspects of a UE 115 as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to early cell switching indication). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to early cell switching indication). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of early cell switching indication as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 420 may be configured to perform various operations (e.g., receiving, monitoring, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to receive information, transmit information, or perform various other operations as described herein.

The communications manager 420 may support wireless communication at a UE in accordance with examples as disclosed herein. For example, the communications manager 420 may be configured as or otherwise support a means for receiving, from a network entity, a downlink message associated with a first RACH procedure between the network entity and the UE, the downlink message including an accessibility indicator of a first cell supported by the network entity, the accessibility indicator indicating whether the first cell is inactive at a future time period. The communications manager 420 may be configured as or otherwise support a means for performing one of the first RACH procedure for the first cell based on the accessibility indicator indicating that the first cell supported by the network entity is active at the future time period or a second RACH procedure for a second cell based on the accessibility indicator indicating that the first cell supported by the network entity is inactive at the future time period.

By including or configuring the communications manager 420 in accordance with examples as described herein, the device 405 (e.g., a processor controlling or otherwise coupled to the receiver 410, the transmitter 415, the communications manager 420, or a combination thereof) may support techniques for reduced processing, reduced power consumption, and more efficient utilization of communication resources, among other examples.

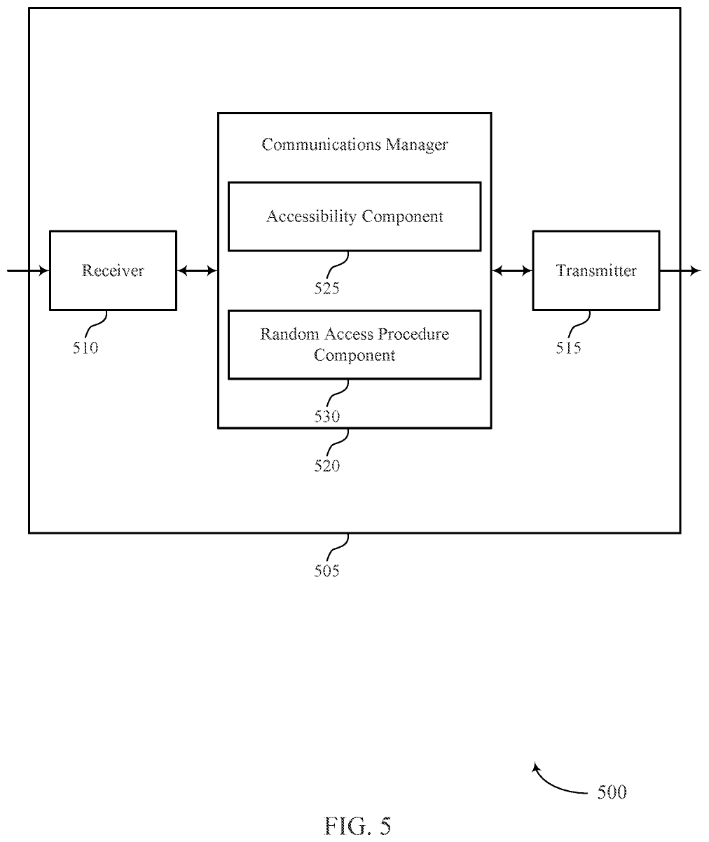

FIG. 5 shows a block diagram 500 of a device 505 that supports early cell switching indication in accordance with aspects of the present disclosure. The device 505 may be an example of aspects of a device 405 or a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to early cell switching indication). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to early cell switching indication). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of early cell switching indication as described herein. For example, the communications manager 520 may include an accessibility component 525 a RACH procedure component 530, or any combination thereof. The communications manager 520 may be an example of aspects of a communications manager 420 as described herein. In some examples, the communications manager 520, or various components thereof, may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communication at a UE in accordance with examples as disclosed herein. The accessibility component 525 may be configured as or otherwise support a means for receiving, from a network entity, a downlink message associated with a first RACH procedure between the network entity and the UE, the downlink message including an accessibility indicator of a first cell supported by the network entity, the accessibility indicator indicating whether the first cell is inactive at a future time period. The RACH procedure component 530 may be configured as or otherwise support a means for performing one of the first RACH procedure for the first cell based on the accessibility indicator indicating that the first cell supported by the network entity is active at the future time period or a second RACH procedure for a second cell based on the accessibility indicator indicating that the first cell supported by the network entity is inactive at the future time period.

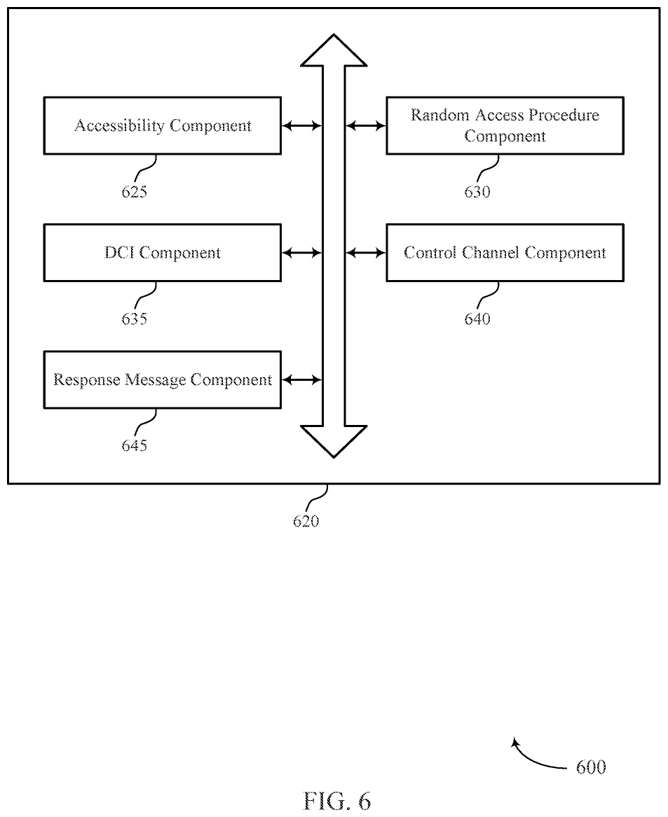

FIG. 6 shows a block diagram 600 of a communications manager 620 that supports early cell switching indication in accordance with aspects of the present disclosure. The communications manager 620 may be an example of aspects of a communications manager 420, a communications manager 520, or both, as described herein. The communications manager 620, or various components thereof, may be an example of means for performing various aspects of early cell switching indication as described herein. For example, the communications manager 620 may include an accessibility component 625, a RACH procedure component 630, a DCI component 635, a control channel component 640, a response message component 645, or any combination thereof. Each of these components may communicate, directly or indirectly, with one another (e.g., via one or more buses).

The communications manager 620 may support wireless communication at a UE in accordance with examples as disclosed herein. The accessibility component 625 may be configured as or otherwise support a means for receiving, from a network entity, a downlink message associated with a first RACH procedure between the network entity and the UE, the downlink message including an accessibility indicator of a first cell supported by the network entity, the accessibility indicator indicating whether the first cell is inactive at a future time period. The RACH procedure component 630 may be configured as or otherwise support a means for performing one of the first RACH procedure for the first cell based on the accessibility indicator indicating that the first cell supported by the network entity is active at the future time period or a second RACH procedure for a second cell based on the accessibility indicator indicating that the first cell supported by the network entity is inactive at the future time period.

In some examples, to support receiving the downlink message, the DCI component 635 may be configured as or otherwise support a means for receiving DCI including scheduling information for a message of the first RACH procedure.

In some examples, to support receiving the downlink message, the DCI component 635 may be configured as or otherwise support a means for receiving DCI including scheduling information for a message of the first RACH procedure, where the first RACH procedure is a four-step RACH procedure and the message is a Msg2 of the four-step RACH procedure.

In some examples, to support receiving the downlink message, the DCI component 635 may be configured as or otherwise support a means for receiving DCI including scheduling information for a message of the first RACH procedure, where the first RACH procedure is a two-step RACH procedure and the message is a MsgB of the two-step RACH procedure.

In some examples, to support receiving the downlink message, the DCI component 635 may be configured as or otherwise support a means for receiving DCI including scheduling information for a message of the first RACH procedure, where the DCI includes a set of multiple reserved bits and the accessibility indicator of the first cell includes a bit of the set of multiple reserved bits.

In some examples, to support receiving the downlink message, the DCI component 635 may be configured as or otherwise support a means for receiving DCI including scheduling information for a message of the first RACH procedure, where the DCI further includes a cyclic redundancy check that is scrambled by an identifier of the message.

In some examples, to support receiving the downlink message, the DCI component 635 may be configured as or otherwise support a means for receiving DCI including scheduling information for a message of the first RACH procedure, where the first RACH procedure is a four-step RACH procedure and the message is a Msg4 of the four-step RACH procedure.

In some examples, to support receiving the downlink message, the control channel component 640 may be configured as or otherwise support a means for receiving a physical downlink control channel including DCI that schedules a message of the first RACH procedure.

In some examples, to support receiving the downlink message, the control channel component 640 may be configured as or otherwise support a means for receiving a physical downlink control channel including DCI that schedules a message of the first RACH procedure, where the physical downlink control channel further includes a demodulation reference signal including the accessibility indicator.

In some examples, to support receiving the downlink message, the control channel component 640 may be configured as or otherwise support a means for receiving a physical downlink control channel including DCI that schedules a message of the first RACH procedure, where the message is a Msg2 or a Msg4.

In some examples, to support receiving the downlink message, the response message component 645 may be configured as or otherwise support a means for receiving a reserved bit of a medium access control sub-header or a medium access control payload of the downlink message, where the downlink message is a response message of the first RACH procedure.

In some examples, to support receiving the downlink message, the response message component 645 may be configured as or otherwise support a means for receiving a reserved bit of a medium access control sub-header or a medium access control payload of the downlink message, where the downlink message is a MsgB of the first RACH procedure.

In some examples, the RACH procedure component 630 may be configured as or otherwise support a means for receiving a message instructing the UE to perform the second RACH procedure for the second cell based on the accessibility indicator indicating that the first cell is inaccessible.

In some examples, to support receiving the message, the accessibility component 625 may be configured as or otherwise support a means for receiving an indication including a cell identifier, a sync raster frequency, a set of RACH parameters, an indication of whether the second cell supports one or more power savings features, or a combination thereof.

In some examples, to support receiving the message, the response message component 645 may be configured as or otherwise support a means for receiving the message via a Msg2 of a four-step RACH procedure, a Msg4 of a four-step RACH procedure, or a MsgB of a two-step RACH procedure.

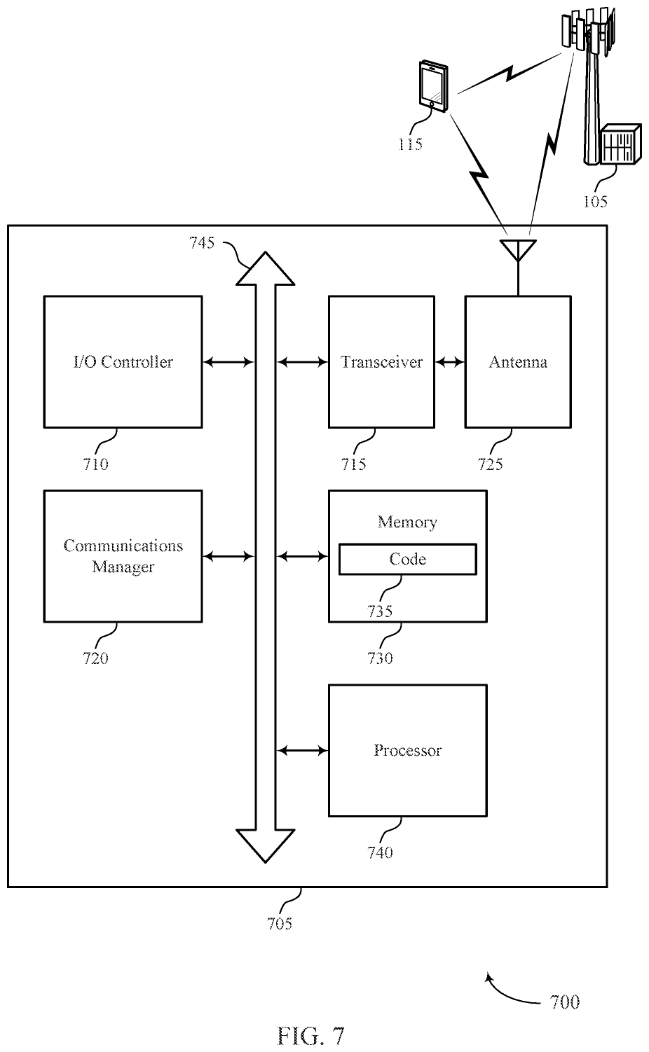

FIG. 7 shows a diagram of a system 700 including a device 705 that supports early cell switching indication in accordance with aspects of the present disclosure. The device 705 may be an example of or include the components of a device 405, a device 505, or a UE 115 as described herein. The device 705 may communicate wirelessly with one or more base stations 105, UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting early cell switching indication). For example, the device 705 or a component of the device 705 may include a processor 740 and memory 730 coupled with or to the processor 740, the processor 740 and memory 730 configured to perform various functions described herein.

The communications manager 720 may support wireless communication at a UE in accordance with examples as disclosed herein. For example, the communications manager 720 may be configured as or otherwise support a means for receiving, from a network entity, a downlink message associated with a first RACH procedure between the network entity and the UE, the downlink message including an accessibility indicator of a first cell supported by the network entity, the accessibility indicator indicating whether the first cell is inactive at a future time period. The communications manager 720 may be configured as or otherwise support a means for performing one of the first RACH procedure for the first cell based on the accessibility indicator indicating that the first cell supported by the network entity is active at the future time period or a second RACH procedure for a second cell based on the accessibility indicator indicating that the first cell supported by the network entity is inactive at the future time period.

By including or configuring the communications manager 720 in accordance with examples as described herein, the device 705 may support techniques for improved communication reliability, reduced latency, and improved user experience, among other examples.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of early cell switching indication as described herein, or the processor 740 and the memory 730 may be otherwise configured to perform or support such operations.

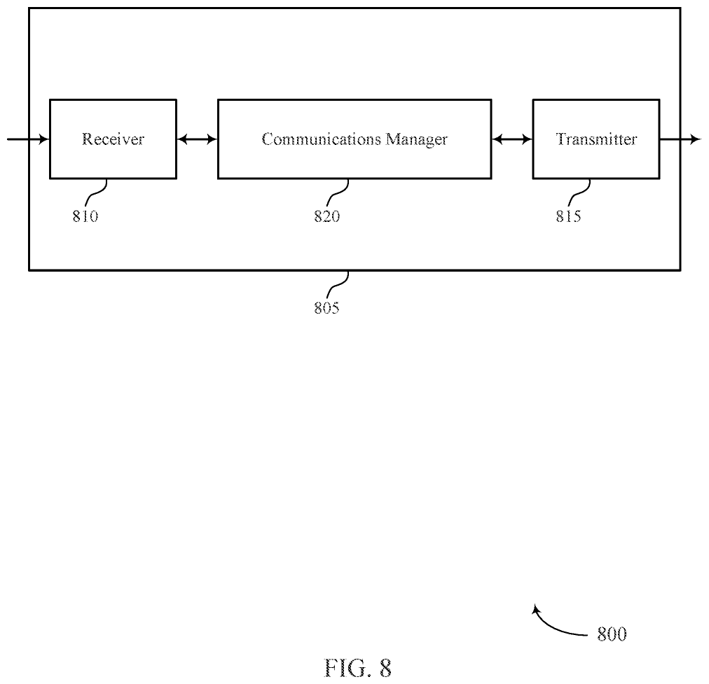

FIG. 8 shows a block diagram 800 of a device 805 that supports early cell switching indication in accordance with aspects of the present disclosure. The device 805 may be an example of aspects of a base station 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to early cell switching indication). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to early cell switching indication). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of early cell switching indication as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 820 may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

The communications manager 820 may support wireless communication at a network entity in accordance with examples as disclosed herein. For example, the communications manager 820 may be configured as or otherwise support a means for receiving, from a UE, an uplink message associated with a RACH procedure between the UE and a cell supported by the network entity. The communications manager 820 may be configured as or otherwise support a means for transmitting, to the UE and in response to the uplink message, a downlink message associated with the RACH procedure between the UE and the cell, the downlink message including an accessibility indicator of the cell supported by the network entity, the accessibility indicator indicating whether the cell is inactive at a future time period.

By including or configuring the communications manager 820 in accordance with examples as described herein, the device 805 (e.g., a processor controlling or otherwise coupled to the receiver 810, the transmitter 815, the communications manager 820, or a combination thereof) may support techniques for reduced processing, reduced power consumption, and more efficient utilization of communication resources, among other examples.

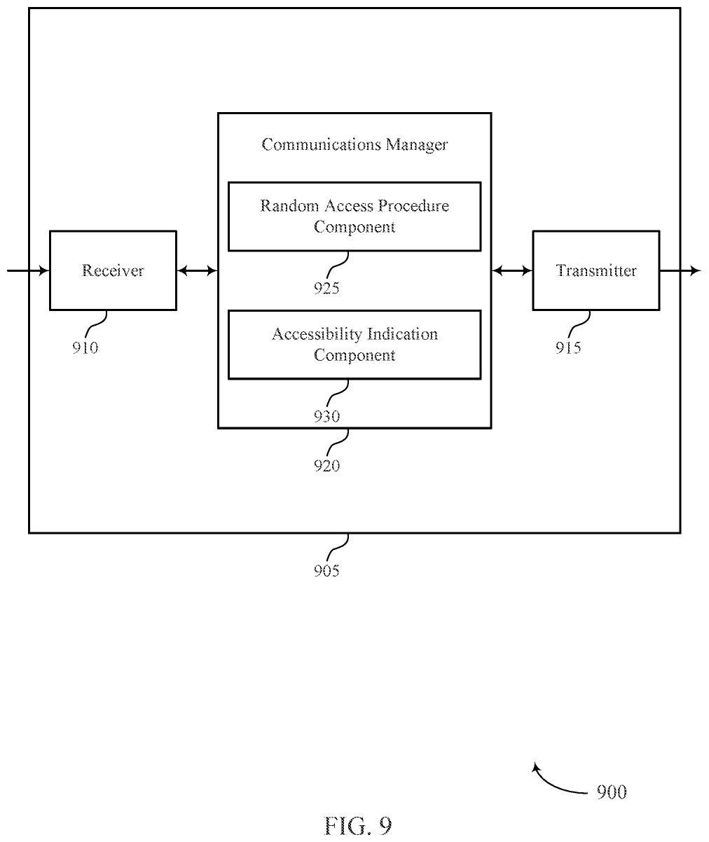

FIG. 9 shows a block diagram 900 of a device 905 that supports early cell switching indication in accordance with aspects of the present disclosure. The device 905 may be an example of aspects of a device 805 or a base station 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to early cell switching indication). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to early cell switching indication). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of early cell switching indication as described herein. For example, the communications manager 920 may include a RACH procedure component 925 an accessibility indication component 930, or any combination thereof. The communications manager 920 may be an example of aspects of a communications manager 820 as described herein. In some examples, the communications manager 920, or various components thereof, may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communication at a network entity in accordance with examples as disclosed herein. The RACH procedure component 925 may be configured as or otherwise support a means for receiving, from a UE, an uplink message associated with a RACH procedure between the UE and a cell supported by the network entity. The accessibility indication component 930 may be configured as or otherwise support a means for transmitting, to the UE and in response to the uplink message, a downlink message associated with the RACH procedure between the UE and the cell, the downlink message including an accessibility indicator of the cell supported by the network entity, the accessibility indicator indicating whether the cell is inactive at a future time period.

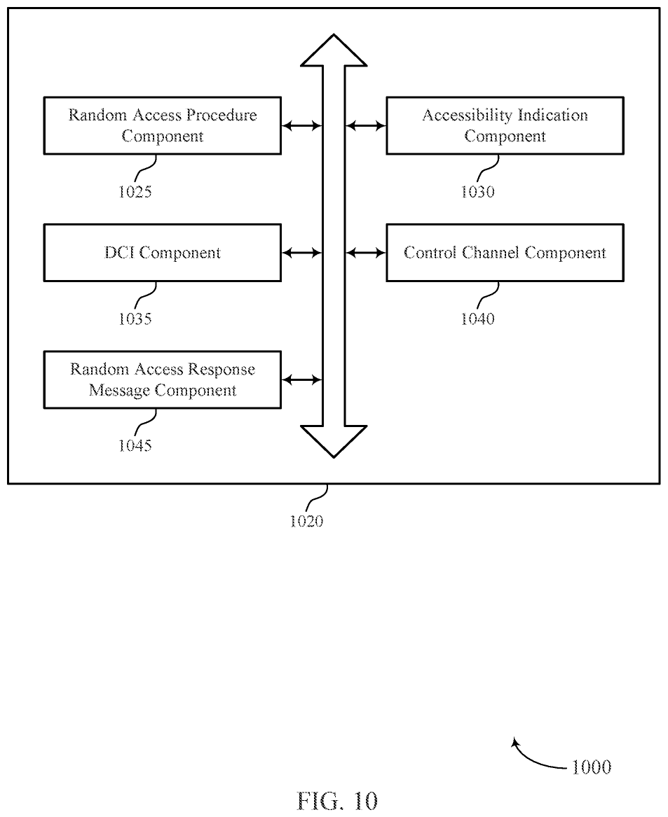

FIG. 10 shows a block diagram 1000 of a communications manager 1020 that supports early cell switching indication in accordance with aspects of the present disclosure. The communications manager 1020 may be an example of aspects of a communications manager 820, a communications manager 920, or both, as described herein. The communications manager 1020, or various components thereof, may be an example of means for performing various aspects of early cell switching indication as described herein. For example, the communications manager 1020 may include a RACH procedure component 1025, an accessibility indication component 1030, a DCI component 1035, a control channel component 1040, a RACH response message component 1045, or any combination thereof. Each of these components may communicate, directly or indirectly, with one another (e.g., via one or more buses).

The communications manager 1020 may support wireless communication at a network entity in accordance with examples as disclosed herein. The RACH procedure component 1025 may be configured as or otherwise support a means for receiving, from a UE, an uplink message associated with a RACH procedure between the UE and a cell supported by the network entity. The accessibility indication component 1030 may be configured as or otherwise support a means for transmitting, to the UE and in response to the uplink message, a downlink message associated with the RACH procedure between the UE and the cell, the downlink message including an accessibility indicator of the cell supported by the network entity, the accessibility indicator indicating whether the cell is inactive at a future time period.

In some examples, to support transmitting the downlink message, the DCI component 1035 may be configured as or otherwise support a means for transmitting DCI including scheduling information for a message of the RACH procedure.

In some examples, to support transmitting the downlink message, the DCI component 1035 may be configured as or otherwise support a means for transmitting DCI including scheduling information for a message of the RACH procedure, where the RACH procedure is a four-step RACH procedure and the message is a Msg2 of the four-step RACH procedure.

In some examples, to support transmitting the downlink message, the DCI component 1035 may be configured as or otherwise support a means for transmitting DCI including scheduling information for a message of the RACH procedure, where the RACH procedure is a two-step RACH procedure and the message is a MsgB of the two-step RACH procedure.

In some examples, to support transmitting the downlink message, the DCI component 1035 may be configured as or otherwise support a means for transmitting DCI including scheduling information for a message of the RACH procedure, where the DCI includes a set of multiple reserved bits and the accessibility indicator of the cell includes a bit of the set of multiple reserved bits.

In some examples, to support transmitting the downlink message, the DCI component 1035 may be configured as or otherwise support a means for transmitting DCI including scheduling information for a message of the RACH procedure, where the DCI further includes a cyclic redundancy check that is scrambled by an identifier of the message.

In some examples, to support transmitting the downlink message, the DCI component 1035 may be configured as or otherwise support a means for transmitting DCI including scheduling information for a message of the RACH procedure, where the RACH procedure is a four-step RACH procedure and the message is a Msg4 of the four-step RACH procedure.

In some examples, to support transmitting the downlink message, the control channel component 1040 may be configured as or otherwise support a means for transmitting a physical downlink control channel including DCI that schedules a message of the RACH procedure.

In some examples, to support transmitting the downlink message, the control channel component 1040 may be configured as or otherwise support a means for transmitting a physical downlink control channel including DCI that schedules a message of the RACH procedure, where the physical downlink control channel further includes a demodulation reference signal including the accessibility indicator of the cell.

In some examples, to support transmitting the downlink message, the control channel component 1040 may be configured as or otherwise support a means for transmitting a physical downlink control channel including DCI that schedules a message of the RACH procedure, where the message is a Msg2 or a Msg4.

In some examples, to support transmitting the downlink message, the RACH response message component 1045 may be configured as or otherwise support a means for transmitting a reserved bit of a medium access control sub-header or a medium access control payload of the downlink message; and where the downlink message is a response message of the RACH procedure.

In some examples, to support transmitting the downlink message, the RACH response message component 1045 may be configured as or otherwise support a means for transmitting a reserved bit of a medium access control sub-header or a medium access control payload of the downlink message, where the downlink message is a MsgB of the RACH procedure.

In some examples, the RACH procedure component 1025 may be configured as or otherwise support a means for transmitting a message instructing the UE to perform a second RACH procedure between UE and a second cell based on the accessibility indicator indicating that the cell is inactive at the future time period.

In some examples, to support transmitting the message, the accessibility indication component 1030 may be configured as or otherwise support a means for transmitting an indication including a cell identifier, a sync raster frequency, a set of RACH parameters, an indication of whether the second cell supports one or more power savings features, or a combination thereof.

In some examples, to support transmitting the message, the RACH response message component 1045 may be configured as or otherwise support a means for transmitting the message via a Msg2 of a four-step RACH procedure, a Msg4 of a four-step RACH procedure, or a MsgB of a two-step RACH procedure.

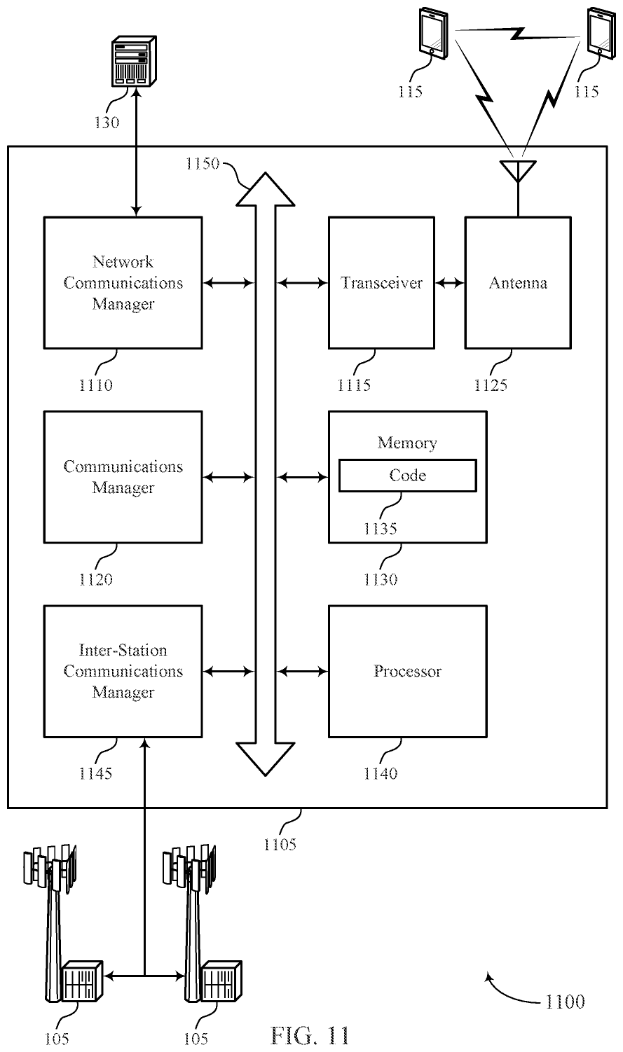

FIG. 11 shows a diagram of a system 1100 including a device 1105 that supports early cell switching indication in accordance with aspects of the present disclosure. The device 1105 may be an example of or include the components of a device 805, a device 905, or a base station 105 as described herein. The device 1105 may communicate wirelessly with one or more base stations 105, UEs 115, or any combination thereof. The device 1105 may include components for bi-directional voice and data communications including components for transmitting and receiving communications, such as a communications manager 1120, a network communications manager 1110, a transceiver 1115, an antenna 1125, a memory 1130, code 1135, a processor 1140, and an inter-station communications manager 1145. These components may be in electronic communication or otherwise coupled (e.g., operatively, communicatively, functionally, electronically, electrically) via one or more buses (e.g., a bus 1150).

The network communications manager 1110 may manage communications with a core network 130 (e.g., via one or more wired backhaul links). For example, the network communications manager 1110 may manage the transfer of data communications for client devices, such as one or more UEs 115.

In some cases, the device 1105 may include a single antenna 1125. However, in some other cases the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include RAM and ROM. The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a BIOS which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting early cell switching indication). For example, the device 1105 or a component of the device 1105 may include a processor 1140 and memory 1130 coupled with or to the processor 1140, the processor 1140 and memory 1130 configured to perform various functions described herein.

The inter-station communications manager 1145 may manage communications with other base stations 105, and may include a controller or scheduler for controlling communications with UEs 115 in cooperation with other base stations 105. For example, the inter-station communications manager 1145 may coordinate scheduling for transmissions to UEs 115 for various interference mitigation techniques such as beamforming or joint transmission. In some examples, the inter-station communications manager 1145 may provide an X2 interface within an LTE/LTE-A wireless communications network technology to provide communication between base stations 105.

The communications manager 1120 may support wireless communication at a network entity in accordance with examples as disclosed herein. For example, the communications manager 1120 may be configured as or otherwise support a means for receiving, from a UE, an uplink message associated with a RACH procedure between the UE and a cell supported by the network entity. The communications manager 1120 may be configured as or otherwise support a means for transmitting, to the UE and in response to the uplink message, a downlink message associated with the RACH procedure between the UE and the cell, the downlink message including an accessibility indicator of the cell supported by the network entity, the accessibility indicator indicating whether the cell is inactive at a future time period.

By including or configuring the communications manager 1120 in accordance with examples as described herein, the device 1105 may support techniques for improved communication reliability, reduced latency, and improved user experience, among other examples.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of early cell switching indication as described herein, or the processor 1140 and the memory 1130 may be otherwise configured to perform or support such operations.

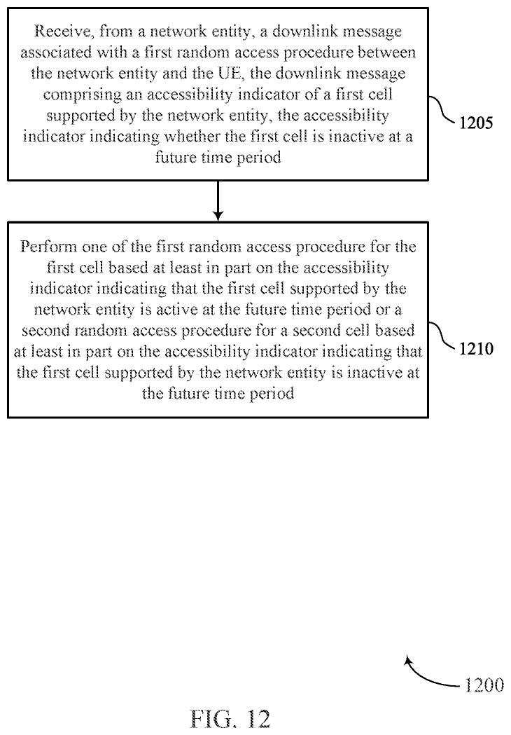

FIG. 12 shows a flowchart illustrating a method 1200 that supports early cell switching indication in accordance with aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally or alternatively, the UE may perform aspects of the described functions using special-purpose hardware.

At 1205, the method may include receiving, from a network entity, a downlink message associated with a first RACH procedure between the network entity and the UE, the downlink message including an accessibility indicator of a first cell supported by the network entity, the accessibility indicator indicating whether the first cell is inactive at a future time period. The operations of 1205 may be performed in accordance with examples as disclosed herein. In some examples, aspects of the operations of 1205 may be performed by an accessibility component 625 as described with reference to FIG. 6.

At 1210, the method may include performing one of the first RACH procedure for the first cell based on the accessibility indicator indicating that the first cell supported by the network entity is active at the future time period or a second RACH procedure for a second cell based on the accessibility indicator indicating that the first cell supported by the network entity is inactive at the future time period. The operations of 1210 may be performed in accordance with examples as disclosed herein. In some examples, aspects of the operations of 1210 may be performed by a RACH procedure component 630 as described with reference to FIG. 6.

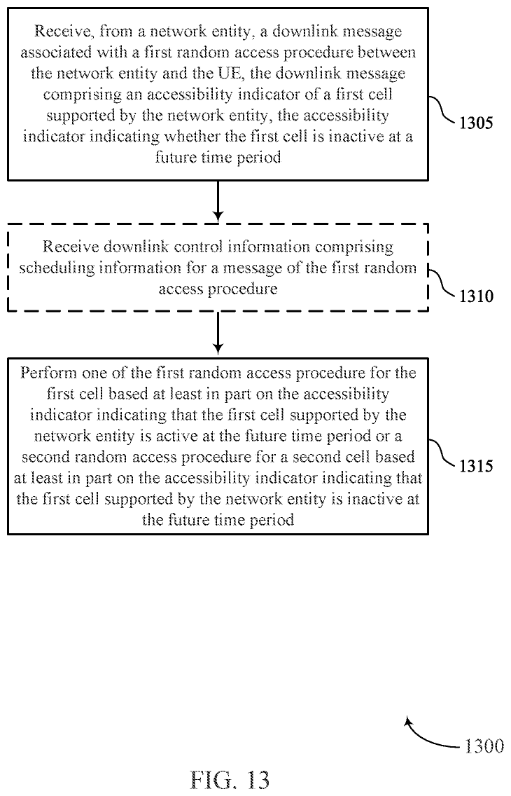

FIG. 13 shows a flowchart illustrating a method 1300 that supports early cell switching indication in accordance with aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally or alternatively, the UE may perform aspects of the described functions using special-purpose hardware.

At 1305, the method may include receiving, from a network entity, a downlink message associated with a first RACH procedure between the network entity and the UE, the downlink message including an accessibility indicator of a first cell supported by the network entity, the accessibility indicator indicating whether the first cell is inactive at a future time period. The operations of 1305 may be performed in accordance with examples as disclosed herein. In some examples, aspects of the operations of 1305 may be performed by an accessibility component 625 as described with reference to FIG. 6.

At 1310, in some examples, the method for receiving the downlink message may include receiving DCI including scheduling information for a message of the first RACH procedure. The operations of 1310 may be performed in accordance with examples as disclosed herein. In some examples, aspects of the operations of 1310 may be performed by a DCI component 635 as described with reference to FIG. 6.

At 1315, the method may include performing one of the first RACH procedure for the first cell based on the accessibility indicator indicating that the first cell supported by the network entity is active at the future time period or a second RACH procedure for a second cell based on the accessibility indicator indicating that the first cell supported by the network entity is inactive at the future time period. The operations of 1315 may be performed in accordance with examples as disclosed herein.

In some examples, aspects of the operations of 1315 may be performed by a RACH procedure component 630 as described with reference to FIG. 6.

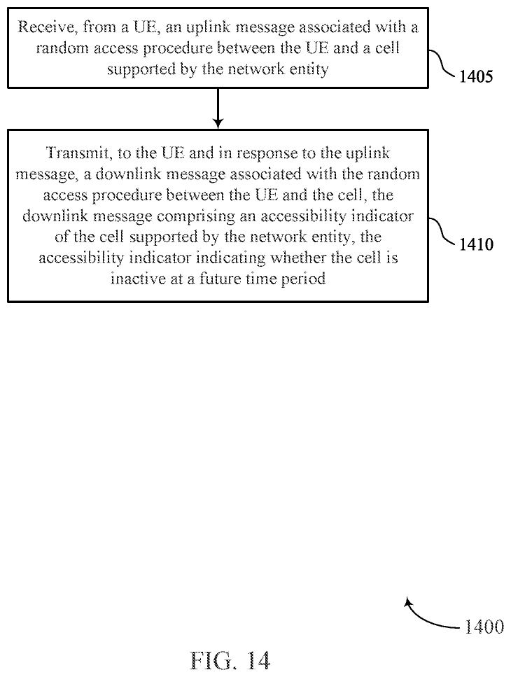

FIG. 14 shows a flowchart illustrating a method 1400 that supports early cell switching indication in accordance with aspects of the present disclosure. The operations of the method 1400 may be implemented by a base station or its components as described herein. For example, the operations of the method 1400 may be performed by a base station 105 as described with reference to FIGS. 1 through 3 and 8 through 11. In some examples, a base station may execute a set of instructions to control the functional elements of the base station to perform the described functions. Additionally or alternatively, the base station may perform aspects of the described functions using special-purpose hardware.

At 1405, the method may include receiving, from a UE, an uplink message associated with a RACH procedure between the UE and a cell supported by the network entity. The operations of 1405 may be performed in accordance with examples as disclosed herein. In some examples, aspects of the operations of 1405 may be performed by a RACH procedure component 1025 as described with reference to FIG. 10.

At 1410, the method may include transmitting, to the UE and in response to the uplink message, a downlink message associated with the RACH procedure between the UE and the cell, the downlink message including an accessibility indicator of the cell supported by the network entity, the accessibility indicator indicating whether the cell is inactive at a future time period. The operations of 1410 may be performed in accordance with examples as disclosed herein. In some examples, aspects of the operations of 1410 may be performed by an accessibility indication component 1030 as described with reference to FIG. 10.

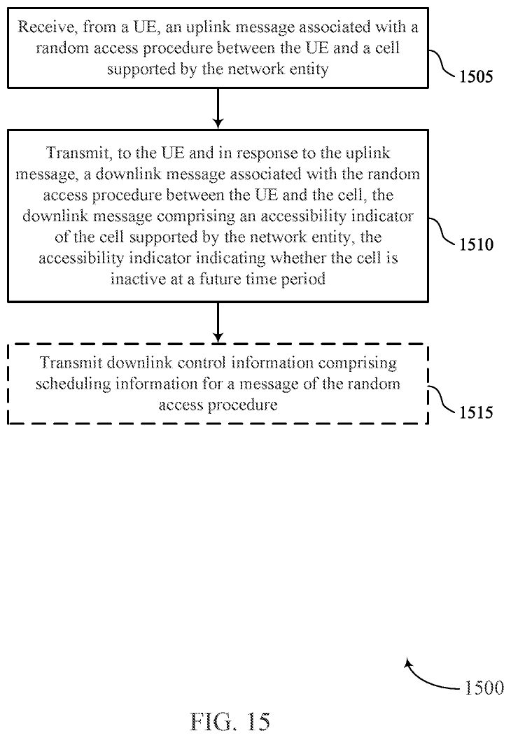

FIG. 15 shows a flowchart illustrating a method 1500 that supports early cell switching indication in accordance with aspects of the present disclosure. The operations of the method 1500 may be implemented by a base station or its components as described herein. For example, the operations of the method 1500 may be performed by a base station 105 as described with reference to FIGS. 1 through 3 and 8 through 11. In some examples, a base station may execute a set of instructions to control the functional elements of the base station to perform the described functions. Additionally or alternatively, the base station may perform aspects of the described functions using special-purpose hardware.

At 1505, the method may include receiving, from a UE, an uplink message associated with a RACH procedure between the UE and a cell supported by the network entity. The operations of 1505 may be performed in accordance with examples as disclosed herein. In some examples, aspects of the operations of 1505 may be performed by a RACH procedure component 1025 as described with reference to FIG. 10.

At 1510, the method may include transmitting, to the UE and in response to the uplink message, a downlink message associated with the RACH procedure between the UE and the cell, the downlink message including an accessibility indicator of the cell supported by the network entity, the accessibility indicator indicating whether the cell is inactive at a future time period. The operations of 1510 may be performed in accordance with examples as disclosed herein. In some examples, aspects of the operations of 1510 may be performed by an accessibility indication component 1030 as described with reference to FIG. 10.

At 1515, in some examples, the method for transmitting the downlink message may include transmitting DCI including scheduling information for a message of the RACH procedure. The operations of 1515 may be performed in accordance with examples as disclosed herein. In some examples, aspects of the operations of 1515 may be performed by a DCI component 1035 as described with reference to FIG. 10.

The following provides an overview of aspects of the present disclosure:

Aspect 1: A method for wireless communication at a UE, comprising: receiving, from a network entity, a downlink message associated with a first random access procedure between the network entity and the UE, the downlink message comprising an accessibility indicator of a first cell supported by the network entity, the accessibility indicator indicating whether the first cell is inactive at a future time period; and performing one of the first random access procedure for the first cell based at least in part on the accessibility indicator indicating that the first cell supported by the network entity is active at the future time period or a second random access procedure for a second cell based at least in part on the accessibility indicator indicating that the first cell supported by the network entity is inactive at the future time period.

Aspect 2: The method of aspect 1, wherein receiving the downlink message comprises: receiving downlink control information comprising scheduling information for a message of the first random access procedure.

Aspect 3: The method of any of aspects 1 through 2, wherein receiving the downlink message comprises: receiving downlink control information comprising scheduling information for a message of the first random access procedure, wherein the first random access procedure is a four-step random access procedure and the message is a Msg2 of the four-step random access procedure.

Aspect 4: The method of any of aspects 1 through 3, wherein receiving the downlink message comprises: receiving downlink control information comprising scheduling information for a message of the first random access procedure, wherein the first random access procedure is a two-step random access procedure and the message is a MsgB of the two-step random access procedure.

Aspect 5: The method of any of aspects 1 through 4, wherein receiving the downlink message comprises: receiving downlink control information comprising scheduling information for a message of the first random access procedure, wherein downlink control information comprises a plurality of reserved bits and the indication of the accessibility of the first cell comprises a bit of the plurality of reserved bits.

Aspect 6: The method of any of aspects 1 through 5, wherein receiving the downlink message comprises: receiving downlink control information comprising scheduling information for a message of the first random access procedure, wherein the downlink control information further comprises a cyclic redundancy check that is scrambled by an identifier of the message.

Aspect 7: The method of any of aspects 1 through 6, wherein receiving the downlink message comprises: receiving downlink control information comprising scheduling information for a message of the first random access procedure, wherein the first random access procedure is a four-step random access procedure and the message is a Msg4 of the four-step random access procedure.

Aspect 8: The method of any of aspects 1 through 7, wherein receiving the downlink message comprises: receiving a physical downlink control channel comprising downlink control information that schedules a message of the first random access procedure.

Aspect 9: The method of any of aspects 1 through 8, wherein receiving the downlink message comprises: receiving a physical downlink control channel comprising downlink control information that schedules a message of the first random access procedure, wherein the physical downlink control channel further comprises a demodulation reference signal comprising the accessibility indicator.

Aspect 10: The method of any of aspects 1 through 9, wherein receiving the downlink message comprises: receiving a physical downlink control channel comprising downlink control information that schedules a message of the first random access procedure, wherein the message is a Msg2 or a Msg4.

Aspect 11: The method of any of aspects 1 through 10, wherein receiving the downlink message comprises: receiving a reserved bit of a medium access control sub-header or a medium access control payload of the downlink message, wherein the downlink message is a response message of the first random access procedure.

Aspect 12: The method of any of aspects 1 through 11, wherein receiving the downlink message comprises: receiving a reserved bit of a medium access control sub-header or a medium access control payload of the downlink message, wherein the downlink message is a MsgB of the first random access procedure.

Aspect 13: The method of any of aspects 1 through 12, further comprising: receiving a message instructing the UE to perform the second random access procedure for the second cell based at least in part on the accessibility indicating that the first cell is inaccessible.

Aspect 14: The method of aspect 13, wherein receiving the message comprises: receiving an indication comprising a cell identifier, a sync raster frequency, a set of random access parameters, an indication of whether the second cell supports one or more power savings features, or a combination thereof.

Aspect 15: The method of any of aspects 13 through 14, wherein receiving the message comprises: receiving the message via a Msg2 of a four-step random access procedure, a Msg4 of a four-step random access procedure, or a MsgB of a two-step random access procedure.

Aspect 16: A method for wireless communication at a network entity, comprising: receiving, from a UE, an uplink message associated with a random access procedure between the UE and a cell supported by the network entity; and transmitting, to the UE and in response to the uplink message, a downlink message associated with the random access procedure between the UE and the cell, the downlink message comprising an accessibility indicator of the cell supported by the network entity, the accessibility indicator indicating whether the cell is inactive at a future time period.

Aspect 17: The method of aspect 16, wherein transmitting the downlink message comprises: transmitting downlink control information comprising scheduling information for a message of the random access procedure.

Aspect 18: The method of any of aspects 16 through 17, wherein transmitting the downlink message comprises: transmitting downlink control information comprising scheduling information for a message of the random access procedure, wherein the random access procedure is a four-step random access procedure and the message is a Msg2 of the four-step random access procedure.

Aspect 19: The method of any of aspects 16 through 18, wherein transmitting the downlink message comprises: transmitting downlink control information comprising scheduling information for a message of the random access procedure, wherein the random access procedure is a two-step random access procedure and the message is a MsgB of the two-step random access procedure.

Aspect 20: The method of any of aspects 16 through 19, wherein transmitting the downlink message comprises: transmitting downlink control information comprising scheduling information for a message of the random access procedure, wherein the downlink control information comprises a plurality of reserved bits and the indication of the accessibility of the cell comprises a bit of the plurality of reserved bits.

Aspect 21: The method of any of aspects 16 through 20, wherein transmitting the downlink message comprises: transmitting downlink control information comprising scheduling information for a message of the random access procedure, wherein the downlink control information further comprises a cyclic redundancy check that is scrambled by an identifier of the message.

Aspect 22: The method of any of aspects 16 through 21, wherein transmitting the downlink message comprises: transmitting downlink control information comprising scheduling information for a message of the random access procedure, wherein the random access procedure is a four-step random access procedure and the message is a Msg4 of the four-step random access procedure.

Aspect 23: The method of any of aspects 16 through 22, wherein transmitting the downlink message comprises: transmitting a physical downlink control channel comprising downlink control information that schedules a message of the random access procedure.

Aspect 24: The method of any of aspects 16 through 23, wherein transmitting the downlink message comprises: transmitting a physical downlink control channel comprising downlink control information that schedules a message of the random access procedure, wherein the physical downlink control channel further comprises a demodulation reference signal comprising the indication of the accessibility of the cell.

Aspect 25: The method of any of aspects 16 through 24, wherein transmitting the downlink message comprises: transmitting a physical downlink control channel comprising downlink control information that schedules a message of the random access procedure, wherein the message is a Msg2 or a Msg4.

Aspect 26: The method of any of aspects 16 through 25, wherein transmitting the downlink message comprises: transmitting a reserved bit of a medium access control sub-header or a medium access control payload of the downlink message; and wherein the downlink message is a response message of the random access procedure.

Aspect 27: The method of any of aspects 16 through 26, wherein transmitting the downlink message comprises: transmitting a reserved bit of a medium access control sub-header or a medium access control payload of the downlink message, wherein the downlink message is a MsgB of the random access procedure.

Aspect 28: The method of any of aspects 16 through 27, further comprising: transmitting a message instructing the UE to perform a second random access procedure between UE and a second cell based at least in part on the accessibility indicator indicating that the cell is inactive at the future time period.

Aspect 29: The method of aspect 28, wherein transmitting the message comprises: transmitting an indication comprising a cell identifier, a sync raster frequency, a set of random access parameters, an indication of whether the second cell supports one or more power savings features, or a combination thereof.

Aspect 30: The method of any of aspects 28 through 29, wherein transmitting the message comprises: transmitting the message via a Msg2 of a four-step random access procedure, a Msg4 of a four-step random access procedure, or a MsgB of a two-step random access procedure.

Aspect 31: An apparatus for wireless communication at a UE, comprising a memory; and a processor coupled to the memory, and configured to perform a method of any of aspects 1 through 15.

Aspect 32: An apparatus for wireless communication at a UE, comprising at least one means for performing a method of any of aspects 1 through 15.

Aspect 33: A non-transitory computer-readable medium storing code for wireless communication at a UE, the code comprising instructions executable by a processor to perform a method of any of aspects 1 through 15.

Aspect 34: An apparatus for wireless communication at a network entity, comprising a memory; and a processor coupled to the memory, and configured to perform a method of any of aspects 16 through 30.

Aspect 35: An apparatus for wireless communication at a network entity, comprising at least one means for performing a method of any of aspects 16 through 30.

Aspect 36: A non-transitory computer-readable medium storing code for wireless communication at a network entity, the code comprising instructions executable by a processor to perform a method of any of aspects 16 through 30.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a memory; and
a processor coupled to the memory, and configured to:
receive, from a network entity, a downlink message associated with a first random access procedure between the network entity and the UE, the downlink message comprising an accessibility indicator of a first cell supported by the network entity, the accessibility indicator indicating whether the first cell is inactive at a future time period; and
perform one of the first random access procedure for the first cell based at least in part on the accessibility indicator indicating that the first cell supported by the network entity is active at the future time period or a second random access procedure for a second cell based at least in part on the accessibility indicator indicating that the first cell supported by the network entity is inactive at the future time period.

2. The apparatus of claim 1, wherein the processor is further configured to:
receive downlink control information comprising scheduling information for a message of the first random access procedure.

3. The apparatus of claim 1, wherein the processor is further configured to:
receive downlink control information comprising scheduling information for a message of the first random access procedure, wherein the first random access procedure is a four-step random access procedure and the message is a Msg2 of the four-step random access procedure.

4. The apparatus of claim 1, wherein the processor is further configured to:
receive downlink control information comprising scheduling information for a message of the first random access procedure, wherein the first random access procedure is a two-step random access procedure and the message is a MsgB of the two-step random access procedure.

5. The apparatus of claim 1, wherein the processor is further configured to:
receive downlink control information comprising scheduling information for a message of the first random access procedure, wherein the downlink control information comprises a plurality of reserved bits and the accessibility indicator of the first cell comprises a bit of the plurality of reserved bits.

6. The apparatus of claim 1, wherein the processor is further configured to:
receive downlink control information comprising scheduling information for a message of the first random access procedure, wherein the downlink control information further comprises a cyclic redundancy check that is scrambled by an identifier of the message.

7. The apparatus of claim 1, wherein the processor is further configured to:
receive downlink control information comprising scheduling information for a message of the first random access procedure, wherein the first random access procedure is a four-step random access procedure and the message is a Msg4 of the four-step random access procedure.

8. The apparatus of claim 1, wherein the processor is further configured to:
receive a physical downlink control channel comprising downlink control information that schedules a message of the first random access procedure.

9. The apparatus of claim 1, wherein the processor is further configured to:
receive a physical downlink control channel comprising downlink control information that schedules a message of the first random access procedure, wherein the physical downlink control channel further comprises a demodulation reference signal comprising the accessibility indicator.

10. The apparatus of claim 1, wherein the processor is further configured to:
receive a physical downlink control channel comprising downlink control information that schedules a message of the first random access procedure, wherein the message is a Msg2 or a Msg4.

11. The apparatus of claim 1, wherein the processor is further configured to:
receive a reserved bit of a medium access control sub-header or a medium access control payload of the downlink message, wherein the downlink message is a response message of the first random access procedure.

12. The apparatus of claim 1, wherein the processor is further configured to:
receive a reserved bit of a medium access control sub-header or a medium access control payload of the downlink message, wherein the downlink message is a MsgB of the first random access procedure.

13. The apparatus of claim 1, wherein the processor is further configured to:
receive a message instructing the UE to perform the second random access procedure for the second cell based at least in part on the accessibility indicator indicating that the first cell is inaccessible.

14. The apparatus of claim 13, wherein the processor is further configured to:
receive the message via a Msg2 of a four-step random access procedure, a Msg4 of a four-step random access procedure, or a MsgB of a two-step random access procedure.

15. An apparatus for wireless communication at a network entity, comprising:
a memory; and
a processor coupled to the memory, and configured to:
receive, from a user equipment (UE), an uplink message associated with a random access procedure between the UE and a cell supported by the network entity; and
transmit, to the UE and in response to the uplink message, a downlink message associated with the random access procedure between the UE and the cell, the downlink message comprising an accessibility indicator of the cell supported by the network entity, the accessibility indicator indicating whether the cell is inactive at a future time period.

16. The apparatus of claim 15, wherein the processor is further configured to:
transmit downlink control information comprising scheduling information for a message of the random access procedure.

17. The apparatus of claim 15, wherein the processor is further configured to:
transmit downlink control information comprising scheduling information for a message of the random access procedure, wherein the random access procedure is a four-step random access procedure and the message is a Msg2 of the four-step random access procedure.

18. The apparatus of claim 15, wherein the processor is further configured to:
transmit downlink control information comprising scheduling information for a message of the random access procedure, wherein the random access procedure is a two-step random access procedure and the message is a MsgB of the two-step random access procedure.

19. The apparatus of claim 15, wherein the processor is further configured to:
transmit downlink control information comprising scheduling information for a message of the random access procedure, wherein the downlink control information comprises a plurality of reserved bits and the accessibility indicator of the cell comprises a bit of the plurality of reserved bits.

20. The apparatus of claim 15, wherein the processor is further configured to:
transmit downlink control information comprising scheduling information for a message of the random access procedure, wherein the downlink control information further comprises a cyclic redundancy check that is scrambled by an identifier of the message.

21. The apparatus of claim 15, wherein the processor is further configured to:
transmit downlink control information comprising scheduling information for a message of the random access procedure, wherein the random access procedure is a four-step random access procedure and the message is a Msg4 of the four-step random access procedure.

22. The apparatus of claim 15, wherein the processor is further configured to:
transmit a physical downlink control channel comprising downlink control information that schedules a message of the random access procedure.

23. The apparatus of claim 15, wherein the processor is further configured to:
transmit a physical downlink control channel comprising downlink control information that schedules a message of the random access procedure, wherein the physical downlink control channel further comprises a demodulation reference signal comprising the accessibility indicator of the cell.

24. The apparatus of claim 15, wherein the processor is further configured to:
transmit a physical downlink control channel comprising downlink control information that schedules a message of the random access procedure, wherein the message is a Msg2 or a Msg4.

25. The apparatus of claim 15, wherein the processor is further configured to:
transmit a reserved bit of a medium access control sub-header or a medium access control payload of the downlink message; and wherein the downlink message is a response message of the random access procedure.

26. The apparatus of claim 15, wherein the processor is further configured to:
transmit a reserved bit of a medium access control sub-header or a medium access control payload of the downlink message, wherein the downlink message is a MsgB of the random access procedure.

27. The apparatus of claim 15, wherein the processor is further configured to:
transmit a message instructing the UE to perform a second random access procedure between UE and a second cell based at least in part on the accessibility indicator indicating that the cell is inactive at the future time period.

28. The apparatus of claim 27, wherein the processor is further configured to:
transmit an indication comprising a cell identifier, a sync raster frequency, a set of random access parameters, an indication of whether the second cell supports one or more power savings features, or a combination thereof.

29. A method for wireless communication at a user equipment (UE), comprising:
receiving, from a network entity, a downlink message associated with a first random access procedure between the network entity and the UE, the downlink message comprising an accessibility indicator of a first cell supported by the network entity, the accessibility indicator indicating whether the first cell is inactive at a future time period; and
performing one of the first random access procedure for the first cell based at least in part on the accessibility indicator indicating that the first cell supported by the network entity is active at the future time period or a second random access procedure for a second cell based at least in part on the accessibility indicator indicating that the first cell supported by the network entity is inactive at the future time period.

30. A method for wireless communication at a network entity, comprising:
receiving, from a user equipment (UE), an uplink message associated with a random access procedure between the UE and a cell supported by the network entity; and
transmitting, to the UE and in response to the uplink message, a downlink message associated with the random access procedure between the UE and the cell, the downlink message comprising an accessibility indicator of the cell supported by the network entity, the accessibility indicator indicating whether the cell is inactive at a future time period.
